(19) United States
(12) Patent Application Publication
(10) Pub. No.: US 2012/0225406 A1
(43) Pub. Date: Sep. 6, 2012

(54) ENDODONTIC TOOL AND METHOD

(76) Inventor: Ghassan YARED, Toronto (CA)

(21) Appl. No.: 13/039,686

(22) Filed: Mar. 3, 2011

(51) Int. Cl. A61C 5/02

(52) U.S. Cl. 433/102; 433/224

(57) ABSTRACT

A reciprocating endodontic hand tool in which the torque applied to an instrument such as a debriding file does not exceed the elastic limit of the file. This reduces or eliminates opportunities for plastic distortion, fatigue and breakage of the file during the canal debriding/cleaning/shaping process. The rotational limits of the instrument may be set at levels that will not subject the instrument to a torque exceeding its elastic limit.

### FIELD OF THE INVENTION

This invention relates to endodontic tools.

### BACKGROUND OF THE INVENTION

An important endodontic procedure, known as a “root canal” procedure, involves removing organic material from the root canals of an infected tooth and filling the canal with an inert obturating material such as gutta percha gum.

An effective root canal procedure avoids extraction of the infected tooth. In this procedure, a dentist or endodontist utilizes a series of endodontic instruments, for example files, for the debridement, cleaning and sterilization of the root canal. These files are rotated within the canal to clean the canal surfaces, removing debridement (organic) material in the process, facilitating improved irrigation, and in some cases shaping the canal for easier filling with the obturating material.

While this procedure used to be done manually, engine-driven (for example motor-driven) rotary tools are now available for providing the rotational motion necessary for the effective debridement and cleaning of the root canal. One of the problems with such tools, however, is that the rotational force is not completely within the control of the dentist or endodontist. Files used for debridement and removal of organic material work like augers, moving material out of the root canal via a helical groove. This effectively makes the file behave like a screw, driving forward when rotated in the forward direction (which may for example, depending upon the orientation of the threads, be the counter-clockwise direction) and backing off when rotated in the reverse (for example clockwise) direction. However, the threads defining the helical groove can lock or catch on interior canal surfaces, especially in constricted and/or curved parts of the canal. If too much force is applied to the file at such points the file can break, necessitating removal of the broken piece of file which can be a difficult procedure which could ultimately result in extraction of the tooth, effectively obviating the benefit of the root canal procedure.

Accordingly, a motor-driven tool has been developed which rotates through a defined arc in a “forward” direction which drives the file into the canal and a defined (typically lesser) arc of rotation in the “reverse” direction which backs the file out of the canal. This reduces opportunities for the file to lock or catch on the inner surfaces of the canal, while effectively debriding, cleaning and shaping the root canal for filling. An example of such a tool is described in U.S. Pat. No. 6,293,795 issued Sep. 25, 2001 to Johnson, which is incorporated herein by reference.

An instrument such as a file used in a canal for debridement will be subjected to stress in the form of torsion (torque). This will cause the structure of the file material, for example metal or plastic, to undergo changes. These changes can be reversible or irreversible, depending on the amount of torque to which the instrument is subjected during the canal debridement. In U.S. Pat. No. 6,293,795 the torque set on the motor may be higher than the elastic limit of the file; also, the arcs of rotation in the forward and reverse directions may subject the tool to torque greater than the elastic limit of the file. Therefore, any changes in the material will be irreversible.

Thus, in the tool described in U.S. Pat. No. 6,293,795, if the instrument locks at a point where a torque higher than the failure point of the particular file is being applied, the file can break in the root canal. If the instrument locks at a point where a torque higher than the elastic limit of the file is being applied, initially a non-visible alteration of the metal structure will occur, and at a higher torque distortion or visible deformation of the file will occur, particularly at a point in the procedure where the debriding file is bending through a curve in the canal. If a debriding file is reused, material fatigue through successive uses can be cumulative, increasing the likelihood of plastic distortion or breaking of the file.

### BRIEF DESCRIPTION OF THE DRAWINGS

In drawings which illustrate by way of example only a preferred embodiment of the invention,

FIG. 1 is a diagrammatic view of a reciprocating endodontic tool according to the invention.

FIG. 2 is a graph showing the preferred torque cut off point in the forward direction according to the invention.

FIG. 3 is a diagrammatic view illustrating preferred forward and reverse rotational arcs according to the invention.

### DETAILED DESCRIPTION OF THE INVENTION

It has been discovered that the root canal procedure can be as effectively accomplished using a reciprocating endodontic hand tool such as that described in U.S. Pat. No. 6,293,795, but in which the torque applied to the debriding file does not exceed the elastic limit of the file. This makes the root canal procedure far safer, considerably reducing or potentially eliminating the possibilities of plastic distortion and fatigue, or breakage of the file during the canal debriding/cleaning/shaping process.

The invention thus provides a hand-held tool for rotating an endodontic instrument for preparing a root canal for filling, the tool comprising a chuck for holding the instrument, a head associated with motor means for rotating the chuck alternately in forward and reverse directions, and a torque sensor for measuring a rotational torque on the chuck, such that the instrument can cut the canal, remove debridement material and advance in the canal, whereby a torque limit on the chuck does not exceed an elastic torque of the instrument.

In further embodiments the tool comprises a control module for setting a torque limit not exceeding an elastic torque of the instrument; a forward arc of rotation of the instrument is greater than a reverse arc of rotation of the instrument; the forward rotational arc of motion of the chuck is set in the range of about 140 degrees to about 160 degrees; the forward rotational arc of motion of the chuck is set at about 140 degrees; a reverse rotational arc of motion of the chuck is set in the range of about 20 degrees to about 90 degrees; the reverse rotational arc of motion of the chuck is set at about 30 degrees; or the forward arc of rotation of the instrument is substantially equal to a reverse arc of rotation of the instrument.

The invention further provides a method of rotating an endodontic instrument in a hand-held tool for preparing a root canal for filling, the tool comprising a chuck for holding the instrument, a head associated with motor means for rotating the chuck alternately in forward and reverse directions, a torque sensor for measuring a rotational torque on the chuck, and a control module, the method comprising, in any order, the steps of: setting a torque limit not exceeding an elastic torque of the instrument whereby the instrument can cut the canal, remove debridement material and advance in the canal, and activating the motor.

Further embodiments of the method may comprise the steps of setting a forward arc of rotation of the instrument at a limit greater than a limit of a reverse arc of rotation of the instrument; setting the forward rotational arc of motion of the chuck in the range of about 140 degrees to about 160 degrees; setting the forward rotational arc of motion of the chuck at about 140 degrees; setting the reverse rotational arc of motion of the chuck in the range of about 20 degrees to about 90 degrees; setting the reverse rotational arc of motion of the chuck at about 30 degrees; or setting a forward arc of rotation of the instrument at a limit substantially equal to a limit of a reverse arc of rotation of the instrument.

According to the invention, instrument fatigue due to torsion (rotation) is virtually eliminated, because below the elastic limit changes in the material (for example metal or plastic) of the instrument 2 due to repeated usage are reversible. In the preferred embodiment the forward and reverse rotational arcs 4a, 4b of the instrument 2 are also selected so as to reduce or eliminate the likelihood that the torque on the file would exceed the elastic limit of the file if the file locks on the canal surfaces, as described below. The lower the torque applied to the instrument 2, the safer the root canal procedure, as long as the endodontic instrument 2 is capable of cutting in the canal, removing debris in an upward direction out of the tooth and advancing in the canal in a downward direction.

An endodontic tool 10 according to the invention thus comprises a handle 12 supporting a rotary head 14 providing a chuck 16 or other attachment means for inserting an instrument 2, such as a debriding file or similar endodontic instrument. The rotary head 14 may be rotated by any suitable means, including electric, pneumatic or hydraulic means, an electric motor 18 being most commonly used as is known to those skilled in the art.

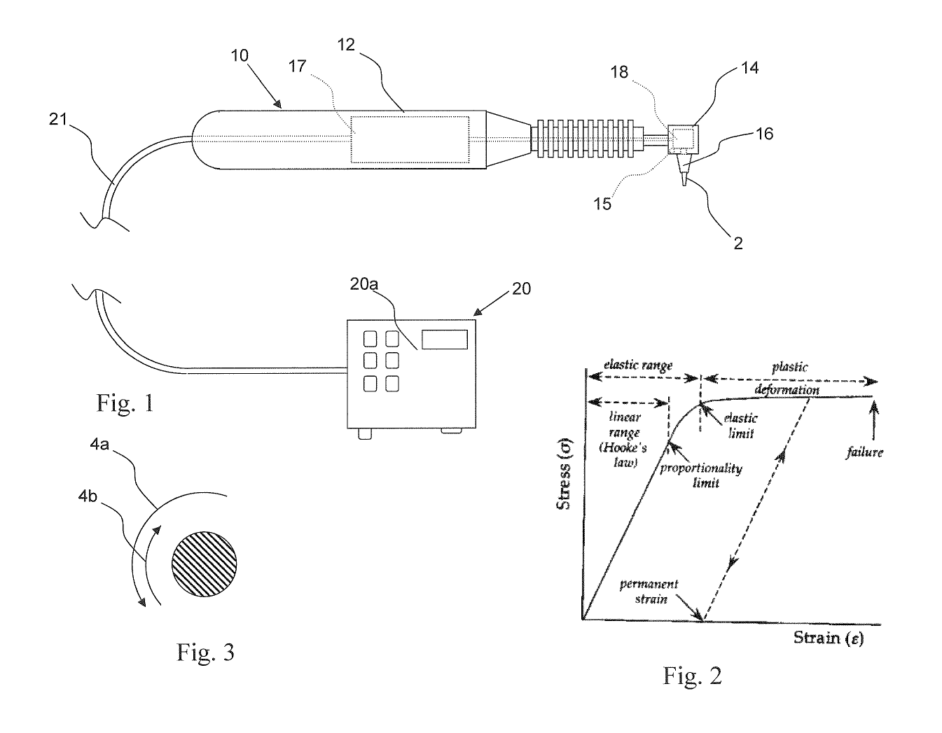

In the table-top version of the tool illustrated in FIG. 1, the handle 12 contains a motor 17 controlled and powered via a power supply cord 21 attached to a control module 20. The motor 17 drives the chuck 16 via a gear train 18 disposed within the rotary head 14. In alternate embodiments (not shown), without limitation, the rotary head may be attached to the motor and the motor connected by a cable to a dental chair system which rotates the motor by any suitable means, including electric, pneumatic or hydraulic means; the control module can be disposed within or on the motor, or within or on the rotary head or part of the dental chair system, for example in a battery-operated hand held device; or the rotary head may provide means for setting the parameters electrically or mechanically. The invention is not limited to any particular configuration or arrangement of the tool 10, motor 17 or drive means 18 used to drive the rotary head 14.

The control module 20 provides controls for the user of the tool 10 to set such parameters as the speed, arc of rotation, torque and others, for example as described in U.S. Pat. No. 6,293,795 which is incorporated herein by reference. An example of a suitable reciprocating endodontic tool is the Endojolly Tecnika Electrodontic Micromotor (Trademark) by ATR, SAS of Pistoia, Italy.

A microprocessor in the control module 20 receives data from the user input into the control module user interface 20a to set the desired parameters for the forward and reverse arcs of rotation 4a, 4b of the reciprocating motion, a torque limit at which the motor 17 will cease rotating in the current direction, and the rotational speed of the chuck (which may differ in the forward and reverse directions). According to the invention, the maximum amount of torque to be applied to the debriding file 2 in the forward and the reverse directions is set so as not to exceed the elastic limit of the specific instrument 2 being used, which may vary according to the composition and configuration of the instrument 2.

In the preferred embodiment the preset forward and reverse arcs of rotation 4a, 4b should not subject the instrument 2 at any particular moment, or in any situation, to a torque (torsional stress) higher than the elastic limit of the specific file 2 being used.

The elastic limit is in part based on the thickness and composition of the instrument 2. Materials such as those used for debriding files have a quantifiable relationship between applied stress and the resulting strain on the material, which can be represented by a stress-strain curve such as that illustrated in FIG. 2. The slope of the stress-strain curve is constant over the region of elastic strain. The point where applied stress causes the onset of permanent deformation is defined as the “elastic limit,” as reflected by the change in the slope of the stress-strain curve.

The elastic limit of the instrument 2 can be determined by stress-strain tests, and may optionally be provided by the manufacturer of the instrument 2 on the packaging or literature accompanying the instrument 2. Ideally the elastic limit is determined by measurements taken at about 1 mm from the tip of the instrument, however tests at this point can be very difficult to realize because the tip of a file is very fine and tends to slip out of the vice connected to the torque sensor. Accordingly, measurements on endodontic instruments are usually taken at 2 to 3 mm from the tip, to determine for example torque at fracture, angle at fracture and other parameters. These measurements may also (or alternatively) be taken at different points along the instrument.

In use, the user (typically an endodontist or dentist) uses the user interface 20a of the control module 20 to set the limits of the forward and reverse rotational arcs 4a, 4b of the reciprocating motion (as shown by way of example in FIG. 3), the speed (or speeds) in the forward and reverse directions, and the torque limit in the forward and reverse directions to be applied before the motor 18 stops rotating in one direction and starts rotating in the opposite direction. The motor 18 will stop rotating in the current direction (for example the forward direction) and start rotating in the opposite direction (for example the reverse direction) when either the preset limit of the arc of rotation is reached or when the preset torque limit is reached in the current direction. The torque sensor 15 in the head 14 delivers torque readings via the cable 21 to the control centre 20, which is programmed to arrest rotation (in the first direction, for example) of the chuck 16 and to reverse its direction of rotation when the programmed torque limit set for the first direction is reached. As noted herein, according to the present invention the preferred torque limit is set at a value not exceeding the elastic limit of the instrument 2, and preferably the lowest torque value which allows the endodontic instrument 2 to cut in the canal, remove debris in an outward direction (i.e. out of the tooth) and advance in the canal.

As noted, the smaller the torque limit, the safer the canal debridement procedure as long as the endodontic file can still cut in the canal, remove debris in an outward direction (out of the tooth) and advance in the canal in an inward direction (deeper into the canal). Thus, according to the present invention the preferred torque limit in the forward and reverse directions set via the control centre 20 should not exceed the elastic limit of the debriding file 2. It has been discovered that this provides a safety advantage without reducing the efficacy of the root canal procedure. The arcs of rotation in the forward and reverse directions 4a, 4b set on the control centre 20 should similarly be set so as not to subject the file 2 to a torque exceeding the elastic limit of the particular endodontic instrument 2 being used.

The rotational arcs 4a, 4b in the forward and reverse directions may be the same, or the rotational arc limit in the forward direction 4a (referred to herein as the direction in which, due to the orientation of the helical thread, the thread of the file 2 will drive the file 2 deeper into the canal) may be less than the rotational arc limit in the reverse direction 4b; however, preferably the rotational arc limit in the forward direction 4a is greater than the rotational arc limit in the reverse direction 4b, as shown in FIG. 3. In the preferred embodiment the forward arc of rotation 4a is set at about 140 to 160 degrees, most preferably about 150 degrees, and the normal reverse arc of rotation 4b (i.e. the rotational arc limit during normal operation of the tool 10 in the absence of excessive torque) is set at about 20 to 90 degrees, most preferably around 30 degrees. Optionally a setting may be provided for a secondary reverse arc of rotation (not shown), engaged when the forward rotational torque limit is exceeded, which may be a different value than the normal reverse arc of rotation 4b.

Any endodontic instrument, rotary or reciprocating, can fracture during the debridement of a root canal. There are three different types of instrument fracture: flexural (bending) fatigue fracture, torsional fatigue fracture and torsional fracture.

Fracture can be caused by flexural fatigue when the instrument is used in a curved canal. Tension/compression cycles are generated on the instrument at the point of maximum flexure. This repeated tension-compression cycle, caused by rotation within curved canals, increases cyclic fatigue of the instrument over time and may be an important factor in instrument fracture. This type of fracture happens mainly in severely curved canals. The best way to reduce the incidence of this type of fracture is by discarding and replacing the instrument frequently.

Torsional fracture occurs when the endodontic instrument 2 used for debridement binds or locks in the canal. It will then be subjected to a stress/torque mainly at its tip. As the motor 18 continues rotating the instrument 2, the force or torque at the tip of the instrument 2 increases and the instrument 2 will eventually fracture at a specific angle of rotation. Each instrument will fracture when subjected to a specific torque, and it will fracture at a specific angle. Every time an instrument is used in a canal it is also subjected to torsional fatigue resulting from the repeated engagement of the canal walls, Like bending or flexular fatigue, torsional fatigue can lead to fracture.

One way to avoid torsional fracture is by setting a maximum amount of torque to be applied to a file that will avoid exceeding breaking stresses (the failure point of the material), as in U.S. Pat. No. 6,293,795. However, in such prior art devices and procedures the torque and the arcs of rotation set on the tool (motor 18) may be within the plastic phase of the instrument, leading to irreversible changes in the instrument material (whether visible or invisible), which could lead to instrument deformation (distortion) and potentially fracture due to fatigue associated with repeated usage of the instrument 2 in the canal.

According to the present invention, the torque limits for the forward and reverse directions are set so as not to exceed the elastic limit of the file. Responsive to the torque sensor 15, the control module 20 switches the motor 18 to the other direction of rotation if the sensed torque reaches the preset limit, which is within the elastic deformation phase. Also, the forward and reverse arcs of rotation 4a, 4b are set to avoid rotation of the instrument 2 to a point where torque to which the instrument 2 is subjected, if it is locked in the canal, would exceed the elastic limit of the instrument 2. The control module 20 will cause the motor 18 to reverse the rotation of the instrument 2 when the preset arc of rotation is completed even if the torque to which the chuck 16 is subjected does not reach the preset torque limit.

In operation, an instrument 2 such as a debridement file is secured to the chuck 16. The operator (typically a dentist or endodontist) uses the user interface 20a to program the control module 20 with at least the torque limit (as determined for the particular instrument 2 being used), and the forward and reverse arcs of rotation 4a, 4b. The user, holding the handle 12 of the tool 10, performs the root canal procedure using the tool 10 to rotate the instrument 2 in reciprocating fashion. The torque sensor 15 sends a constant (or frequent intermittent) signal to the control module 20 while the instrument 2 is rotating. If the instrument 2 bites into the canal to the point that the torque against the instrument 2 exceeds the preset torque limit, the control module 20 reverses the rotational direction for a preset torque-relief rotational arc (which may be the same as the normal reverse rotational arc 4b, or may be set at a different value).

Various embodiments of the present invention having been thus described in detail by way of example, it will be apparent to those skilled in the art that variations and modifications may be made without departing from the invention. The invention includes all such variations and modifications as fall within the scope of the appended claims.

I claim:

1. A hand-held tool for rotating an endodontic instrument for preparing a root canal for filling, the tool comprising
a chuck for holding the instrument,
a head associated with motor means for rotating the chuck alternately in forward and reverse directions,
a torque sensor for measuring a rotational torque on the chuck, and
such that the instrument can cut the canal, remove debridement material and advance in the canal whereby a torque limit on the chuck does not exceed an elastic torque of the instrument.

2. The tool of claim 1 comprising a control module for setting a torque limit not exceeding an elastic torque of the instrument.

3. The tool of claim 1 wherein a forward arc of rotation of the instrument is greater than a reverse arc of rotation of the instrument.

4. The tool of claim 3 wherein the forward rotational arc of motion of the chuck is set in the range of about 140 degrees to about 160 degrees.

5. The tool of claim 4 wherein the forward rotational arc of motion of the chuck is set at about 140 degrees.

6. The tool of claim 3 wherein the reverse rotational arc of motion of the chuck is set in the range of about 20 degrees to about 90 degrees.

7. The tool of claim 6 wherein the reverse rotational arc of motion of the chuck is set at about 30 degrees.

8. The tool of claim 1 wherein a forward arc of rotation of the instrument is substantially equal to a reverse arc of rotation of the instrument.

9. A method of rotating an endodontic instrument in a hand-held tool for preparing a root canal for filling, the tool comprising a chuck for holding the instrument, a head associated with motor means for rotating the chuck alternately in forward and reverse directions, a torque sensor for measuring a rotational torque on the chuck, and a control module, the method comprising, in any order, the steps of:
setting a torque limit not exceeding an elastic torque of the instrument whereby the instrument can cut the canal, remove debridement material and advance in the canal, and
activating the motor.

10. The method of claim 9 further comprising, at any time, setting a forward arc of rotation of the instrument at a limit greater than a limit of a reverse arc of rotation of the instrument.

11. The method of claim 10 comprising the step of setting the forward rotational arc of motion of the chuck in the range of about 140 degrees to about 160 degrees.

12. The method of claim 11 comprising the step of setting the forward rotational arc of motion of the chuck at about 140 degrees.

13. The method of claim 10 comprising the step of setting the reverse rotational arc of motion of the chuck in the range of about 20 degrees to about 90 degrees.

14. The method of claim 13 comprising the step of setting the reverse rotational arc of motion of the chuck at about 30 degrees.

15. The method of claim 9 comprising the step of setting a forward arc of rotation of the instrument at a limit substantially equal to a limit of a reverse arc of rotation of the instrument.
